(19) United States
(12) Patent Application Publication
(10) Pub. No.: US 2006/0133087 A1
(43) Pub. Date: Jun. 22, 2006

(54) Twist light

(76) Inventor: Ming-Kuei Lin, Taipei Hsien (TW)

Correspondence Address: DAVID E. DOUGHERTY;Dennison, Schultz, Dougherty & MacDonald, Suite 105, 1727 King Street, Alexandria, VA, 22314-2700, US

(21) Appl. No.: 11/014,879

(22) Filed: Dec. 20, 2004

(51) Int. Cl. F21V 21/26

(52) U.S. Cl. 362/271

(57) ABSTRACT

A twist light includes a base, a motor, a gear set, two torsion rods, a light source and a plurality of ring. The motor and the gear set are arranged inside the base. The motor drives the gear set so as to rotate the two torsion rods synchronously in the same direction. The two torsion rods with the same arc stand on two lateral sides of the base. The ring is a translucent ring with certain width and is inserted by the two torsion rods through the two insertion holes thereof. Thus a step-like shade is formed. The light source is disposed inside the step-like shade. A graphic shade encloses the light source. When the torsion rods swivel synchronously in the same direction, the step-like shade is driven and moved twistingly. Thus the graphic images projected on the step-like shade is getting smaller and getting larger correspondingly.

### BACKGROUND OF THE INVENTION

The present invention relates to a twist light, especially a light having a plurality of translucent ring stacked on two torsion rods with the same arc in parallel to form a step-like shade. A light source is disposed inside the step-like shade with a graphic shade enclosing the light source. When the torsion rods swivel synchronously in the same direction, the step-like shade is driven and moved twistingly. Thus the graphic images projected on the step-like shade is getting smaller and getting larger correspondingly.

There are various designs of lights. Some are emphasized on the function of lighting while others focus on ornamental quality. Most of them are static-design. However, present invention provides a novel light for lighting, decoration, and dynamic displaying.

### SUMMARY OF THE INVENTION

It is therefore a primary object of the present invention to provide a twist light including a base, a motor, a gear set, two torsion rods, a light source and a plurality of ring. The motor and the gear set are arranged inside the base. The motor drives the gear set so as to rotate the two torsion rods synchronously in the same direction. The two torsion rods with the same arc stand on two lateral sides of the base. The ring is a translucent ring with certain width and is inserted by the two torsion rods through the two insertion holes thereof. Thus a step-like shade is formed. The light source is disposed inside the step-like shade. In usage, the torsion rods swivel synchronously in the same direction, the step-like shade is driven and moved twistingly.

It is another object of the present invention to provide a twist light with a graphic shade encloses the light source so that the light passes through the graphic shade to form images projected on the step-like shade. By the twisting of the step-like shade, the distance between the graphic shade and the step-like shade sometimes increases and sometimes decreases. Thus the images projected on the step-like shade is getting smaller and getting larger correspondingly. Therefore, a better visual effect of light and shade is achieved.

It is a further object of the present invention to provide a twist light having an accessorial gear set driven by the gear set so as to drive the graphic shade revolving. Therefore, the images projected on the step-like shade also rotates, a better-visual effect is achieved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment of the present invention;

FIG. 2 is a front view of the embodiment in FIG. 1;

FIG. 3 is a cross-sectional view of the embodiment in FIG. 1;

FIG. 4 is a partial explosive view of the embodiment in FIG. 1;

FIG. 5 is another partial explosive view of the bottom of the embodiment in FIG. 1;

FIG. 6 is a cross-sectional view of another embodiment of the present invention;

FIG. 7 is a partial explosive view of the embodiment in FIG. 6;

FIG. 8 is a cross-sectional view of a further embodiment of the present invention;

FIG. 9 is a partial explosive view of the embodiment in FIG. 8.

### DETAILED DESCRIPTION OF THE PREFFERED EMBODIMENT

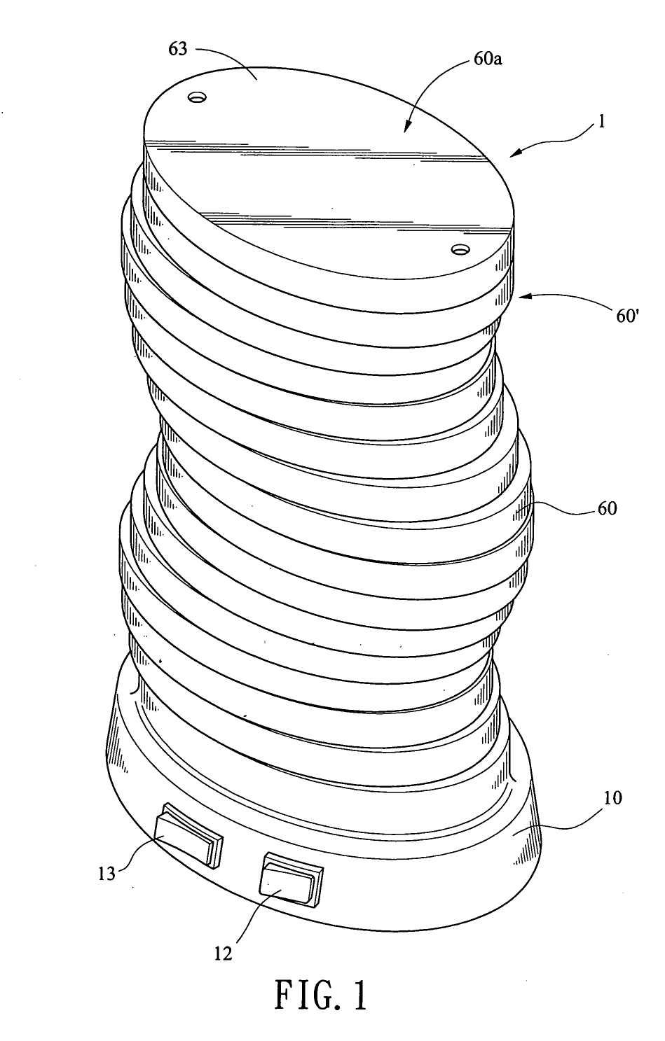

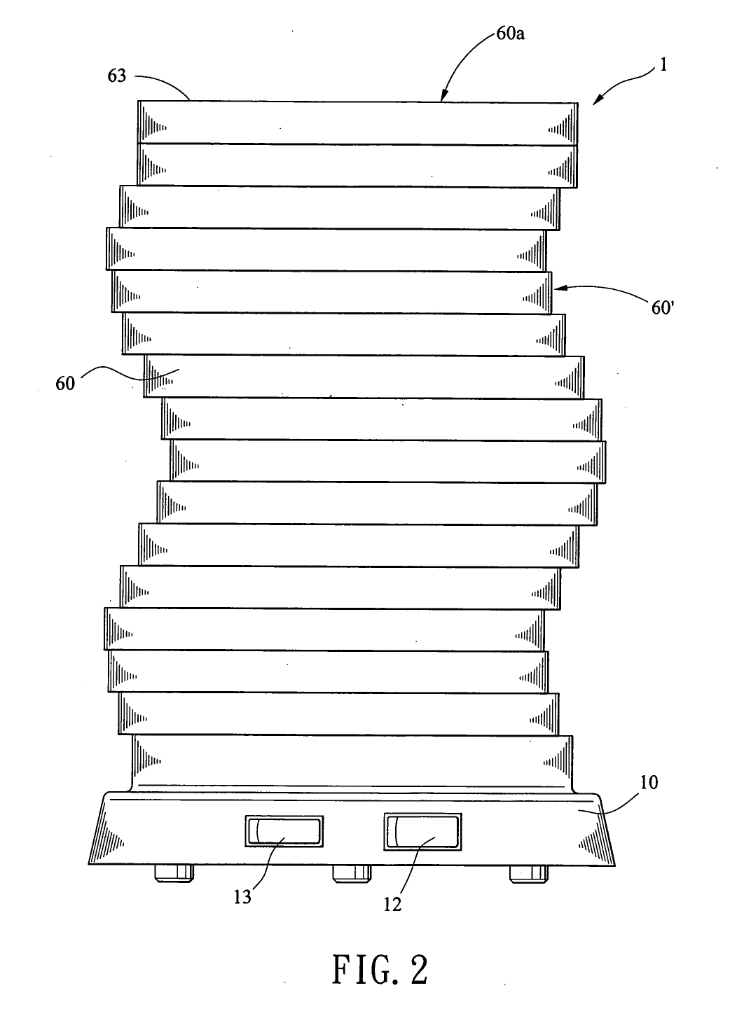

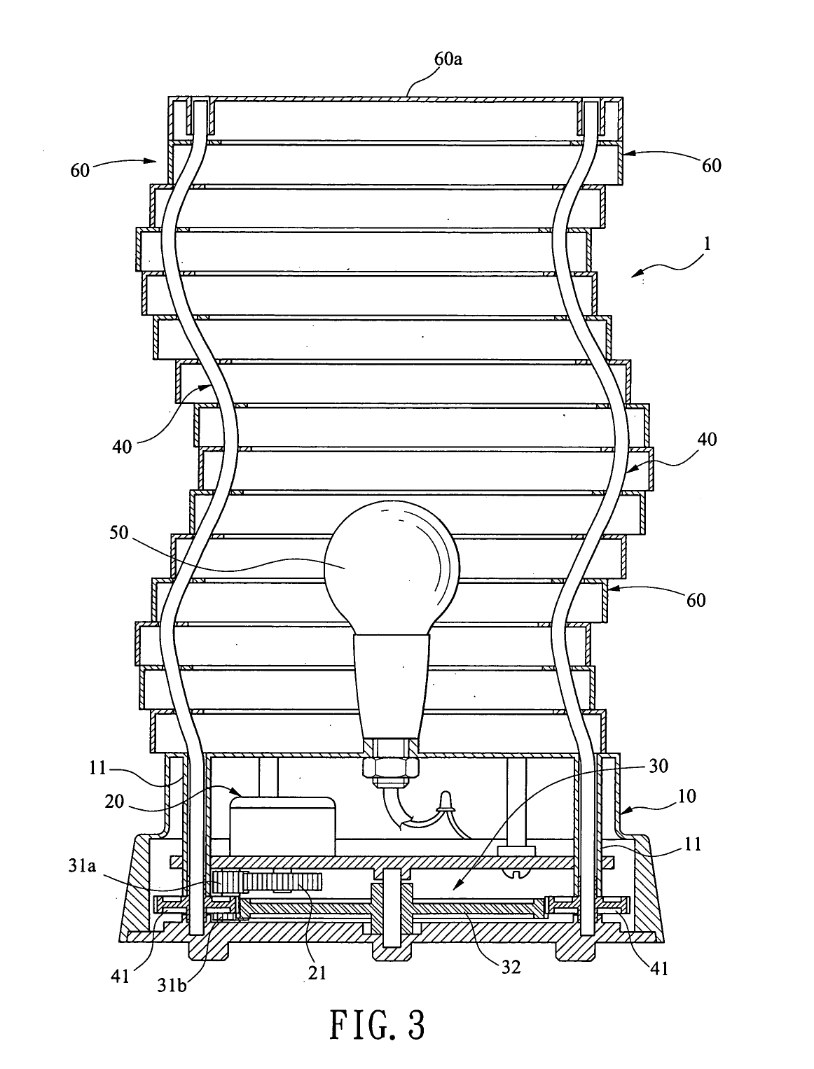

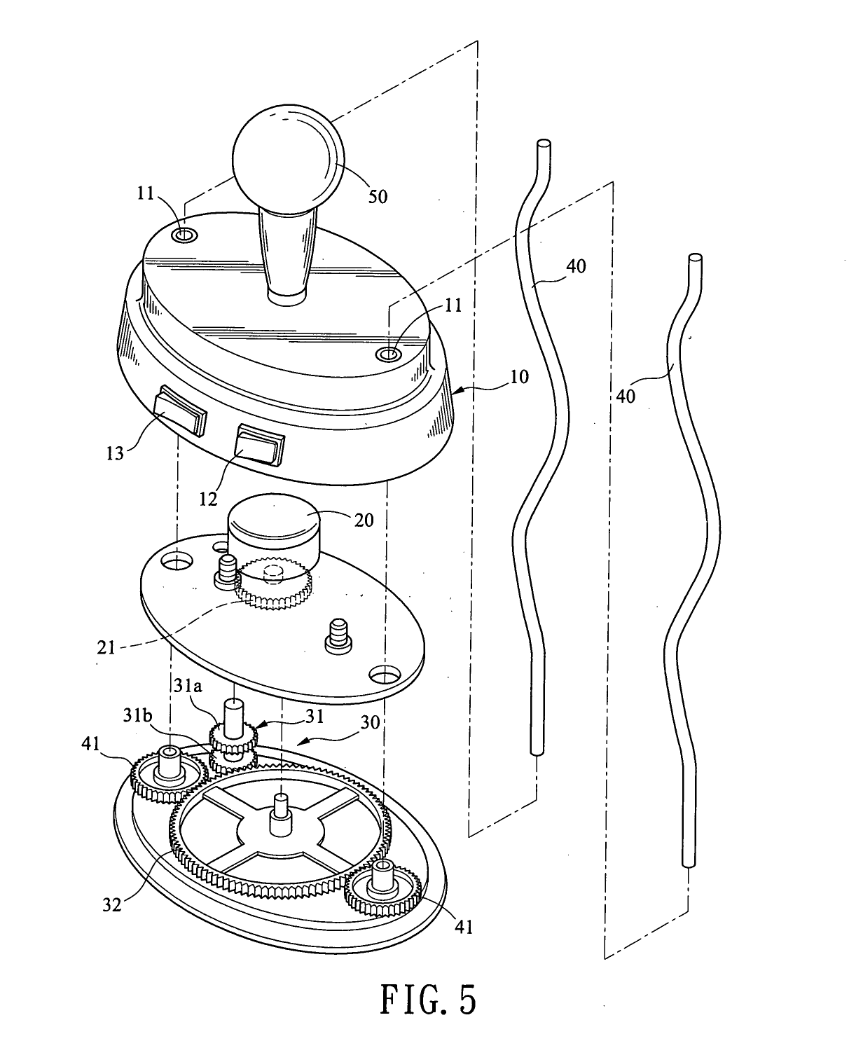

Refer to FIG. 1 & FIG. 2, a twist light 1 is composed of a base 10, a motor 20, a gear set 30, two torsion rods 40, a light source and a plurality of ring 60. The motor 20 and the gear set 30 are disposed inside the base 10. Refer from FIG. 3 to FIG. 5, the gear set 30 is driven by a driving gear 21 of the motor 20. The gear set 30 includes a coaxial twin-gear 31 and a large gear 32. The driving gear 21 of the motor 20 drives an upper gear 31a so as to make a lower gear 31b of the coaxial twin gear 31 rotate the large gear 32. While the two torsion rods 40 are S-shaped or wavy cylindrical rods with the same arc whose bottom side is inserted into the two sleeves 11 arranged on two lateral sides of the base 10. Thus the two torsion rods 40 stand on two lateral sides of the base 10 and rotate. Refer to FIG. 5, a gear 41 is positioned on the bottom of each of the torsion rod 40 and is joined with the large gear 32 so as to make the two torsion rods 40 rotates synchronously and in the same direction by the driving of the gear set 30.

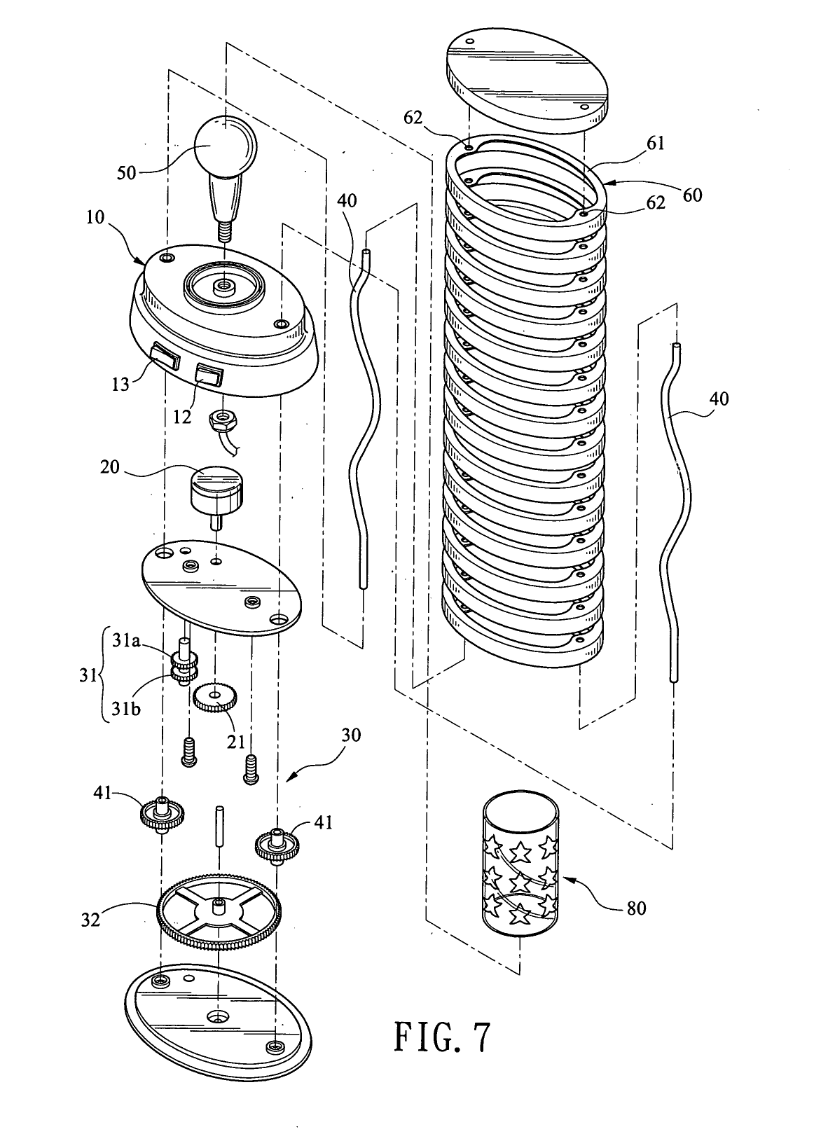

Refer to FIG. 7, the ring 60 is a translucent ring with certain width and is arranged in parallel with each other. The shape of the ring 60 is elliptic. The color of each of the rings 60 can be different. A flange face 61 with certain thickness and two insertion holes 62 on lateral sides is disposed on the top side of the ring 60. The diameter of the insertion holes 62 is a bit larger than that of the torsion rod 40 and the distance between the two insertion holes 62 corresponds to that of the two torsion rods 40. By the two torsion rods 40 inserting trough the insertion holes 62, a plurality of ring 60 is stacked in parallel on the base 10 so as to form a step-like shade 60′ that has the same arc with the torsion rods 40. Refer to FIG. 1, the top ring 60a having a covering surface 63 so as to cover the top of the step-like shade 60′ and the torsion rods 40.

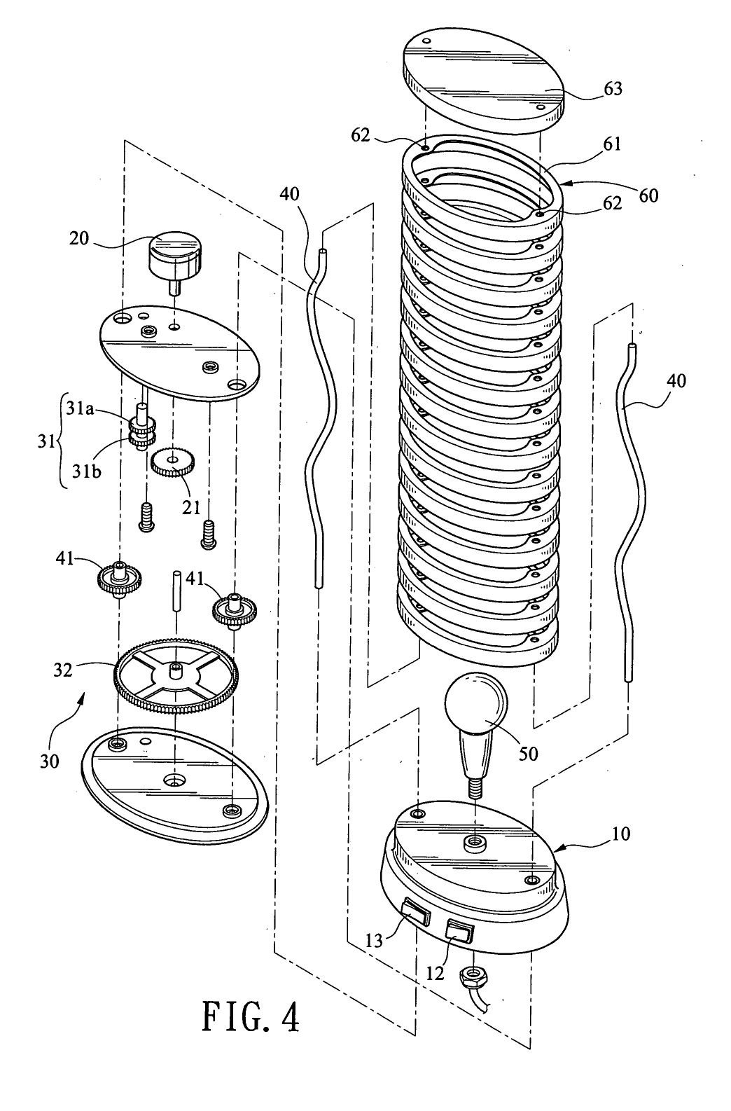

Refer to FIG. 4, a light source 50 (such as a light bulb) is disposed on the center of the vase 10. Switches such as a lighting switch 12 and a motor switch 13 for turning on and off of the light source 50 (light bulb) and the motor 20 are disposed on the base 10. In usage, the torsion rods 40 rotates synchronously in the same direction so as to drive the step-like shade 60′ twisting and make the twist lamp 1 have dynamic decorative effect.

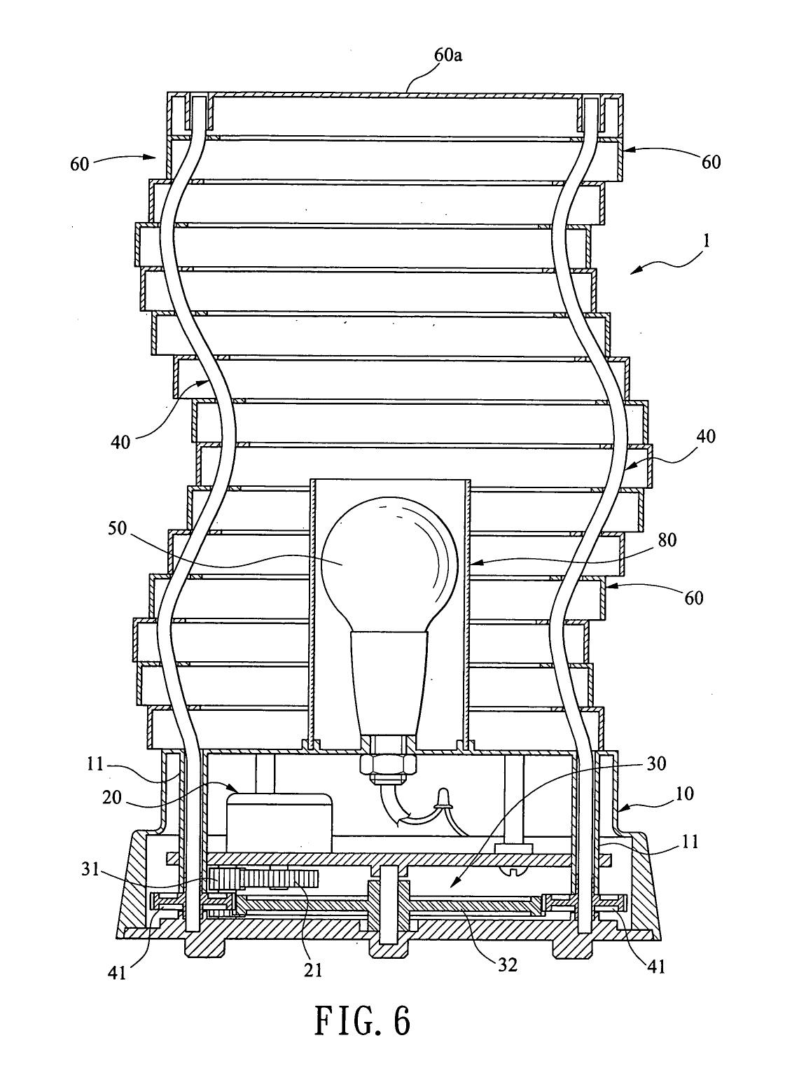

Refer to FIG. 6 & FIG. 7, the twist lamp 1 in accordance with the present invention further includes a graphic shade 80 enclosing the light source 50 so that the light emitted from the light source 50 passes through the figures on the graphic shade 80 and projects on the step-like shade 60′. By the twisting of the step-like shade 60′, the distance between the graphic shade 80 and the step-like shade 60′ sometimes increases and sometimes decreases. Thus the images projected on the step-like shade 60′ is getting smaller and getting larger correspondingly. Therefore, a better visual effect of light and shade is achieved.

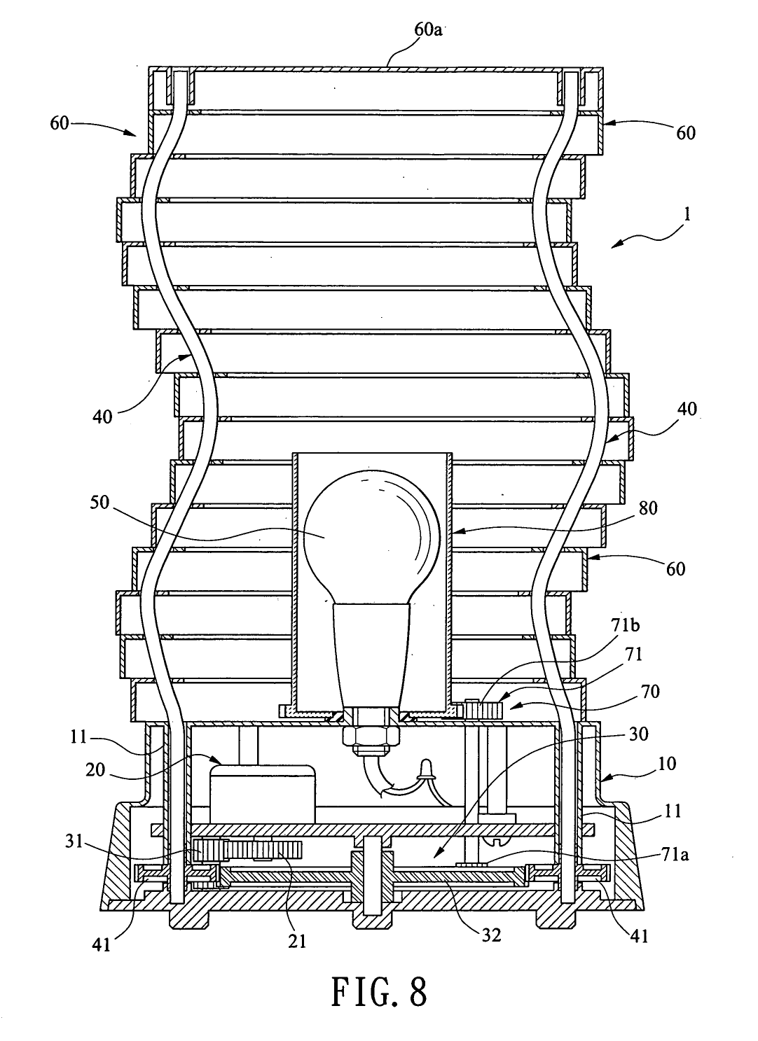

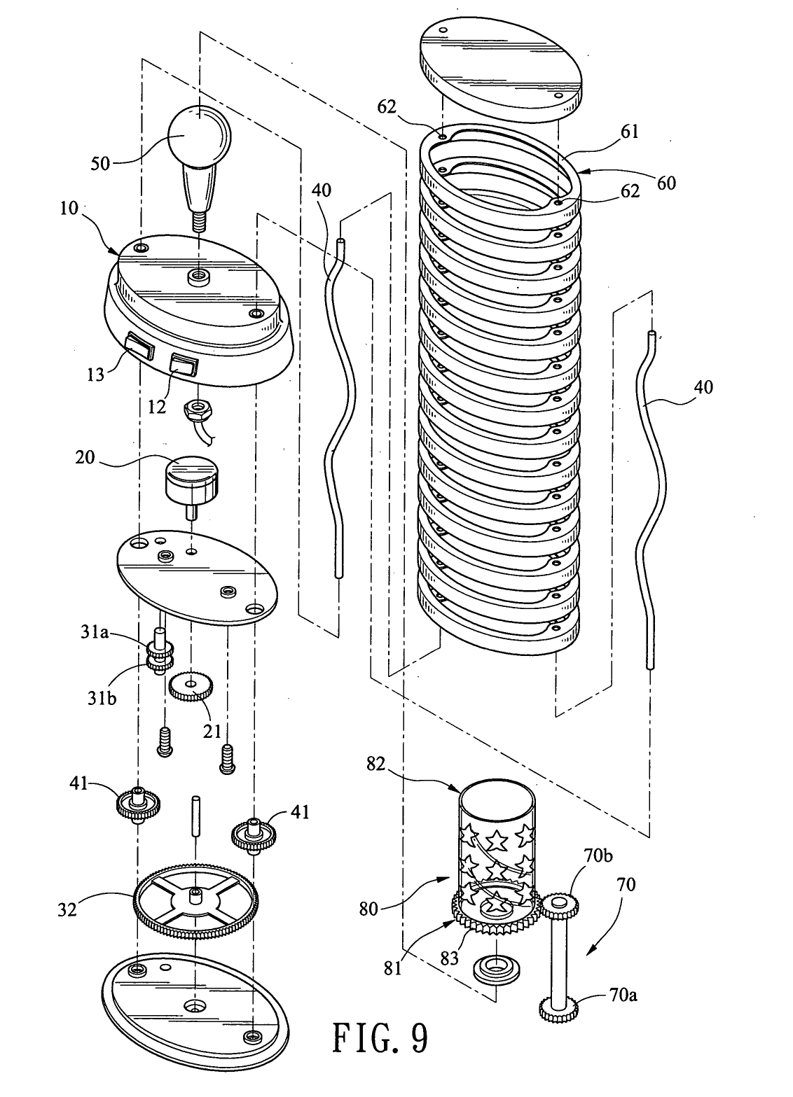

Refer to FIG. 8 & FIG. 9, the twist lamp 1 in accordance with the present invention further having an accessorial gear set 70 that is driven by the gear set 30. The accessorial gear set 70 is used to drive the graphic shade 80 rotating around the light source 50 so that the images projected on the step-like shade 60′ can also circle. The accessorial gear set 70 includes a coaxial twin-gear 71 and a lower gear 71a of the coaxial twin-gear 71 is connected and driven by the large gear 32 of the gear set 30 while an upper gear 71b of the coaxial twin-gear 71 also swivels and drives the graphic shade 80 turning around. The graphic shade 80 includes a swivel seat 81 and a graphic piece 82. The swivel seat 81 is arranged on the bottom of the light source 50 (light bulb) and is rotatable with a tooth face 83 on the circumference driven by the upper gear 71b. The graphic piece 82 is a transparent film with various figures. While being used, the graphic shade 80 is driven by the gear set 30 and the accessorial gear set 70 and is revolving.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A twist light comprising
a base, a motor, a gear set, two torsion rods, a plurality of ring and a light source, wherein
the inner side of the base is used for accommodating the motor and the gear set;
the motor having a driving gear, connected with an external source of power for driving gear set;
the gear set is driven by the motor and is used to drive the two torsion rods swiveling synchronously in the same direction;
the torsion rods are cylindrical rods with the same arc, each is arranged on the lateral side of the base; the bottom side thereof is inserted into each of the two sleeves arranged on two lateral sides of the base; a gear connected with and driven by the gear set is disposed on the bottom side thereof for rotating the two torsion rods synchronously in the same direction;
the ring is a translucent ring with certain width and having two insertion holes on two lateral sides of a flange face thereof; diameter of the insertion holes is a bit larger than the diameter of the torsion rod and the distance between the two insertion holes corresponds to the distance of the two torsion rods so as to make the two torsion rods insert trough the insertion holes of the ring; thus the rings stacked in parallel on the base so as to form a multi-layer step-like shade;
the light source is disposed inside the step-like shade and is connected to an external power source.

2. The twist light as claimed in claim 1, wherein the gear set includes a coaxial twin-gear and a large gear; the driving gear of the motor drives an upper gear of the coaxial twin-gear so as to make a lower gear of the coaxial twin-gear drive the large gear that drives the gears on the bottom of the torsion rods for revolving the torsion rods synchronously in the same direction.

3. The twist light as claimed in claim 1, wherein each of the ring is in different color.

4. The twist light as claimed in claim 1, wherein the ring is elliptic.

5. The twist light as claimed in claim 1, wherein a lighting switch and a motor switch for turning on and off of the light source and the motor are disposed on the base.

6. The twist light as claimed in claim 1, wherein a graphic shade is arranged around the light source so as to make the light from the light source pass the graphic shade and then project on the step-like sahde.

7. The twist light as claimed in claim 1, wherein the twist light further having an accessorial gear set driven by the hear set for driving the graphic shade around the light source.

8. The twist light as claimed in claim 1, wherein the graphic shade having a swivel seat and a graphic piece; and the accessorial gear set having a coaxial twin-gear with a lower gear and an upper gear; the lower gear is connected and driven by the large gear of the gear set while the upper gear drives the swivel seat that is arranged on the bottom of the light source.
